(19) United States
(12) Patent Application Publication
(10) Pub. No.: US 2021/0109888 A1
(43) Pub. Date: Apr. 15, 2021

(54) PARALLEL PROCESSING BASED ON INJECTION NODE BANDWIDTH

(71) Applicant: Intel Corporation, Santa Clara, CA (US)

(72) Inventors: Karthikeyan Vaidyanathan, Bangalore (IN); Srinivas Sridharan, Bangalore (IN); Dipankar Das, Pune (IN)

(21) Appl. No.: 16/642,483

(22) PCT Filed: Sep. 30, 2017
(86) PCT No.: PCT/US17/54663

§ 371 Date: Feb. 27, 2020

(51) Int. Cl. G06F 15/163

(52) U.S. Cl. CPC G06F 15/163

(57) ABSTRACT

A technique includes performing a collective operation among multiple nodes of a parallel processing computer system using multiple parallel processing stages. The technique includes regulating an ordering of the parallel processing stages so that an initial stage of the plurality of parallel processing stages is associated with a higher node injection bandwidth than a subsequent stage of the plurality of parallel processing stages.

### BACKGROUND

A parallel computing system may include a plurality of hardware processing nodes, such as central processing units (CPUs), graphical processing units (GPUs) and so forth. In general, a given node performs its processing independently of the other nodes of the parallel computing system.

A given application written for a parallel processing system may involve collective operations in which the nodes communicate with each other to exchange data. One type of collective operation is a reduce-scatter operation in which input data may be processed in a sequence of parallel processing phases, or stages. In this manner, each processing node may begin the operation with a data vector, or array, which represents part of an input data vector; and in each stage, pairs of the processing nodes may exchange half of their data and combine the data (add the data together, for example) to reduce the data. In this manner, the collective processing reduces the data arrays initially stored on each of the nodes into a final data array representing the result of the collective operation, and the final data array may be distributed, or scattered, across the processing nodes.

### BRIEF DESCRIPTION OF THE DRAWINGS

FIG. 1 is a schematic diagram of a parallel processing computer system according to an example implementation.

FIG. 2 is an illustration of a node execution environment according to an example implementation.

FIG. 3 is an illustration of processing stages used by the parallel processing computer system to perform a collective operation according to an example implementation.

FIG. 4A is an illustration of initial data arrays stored on processing nodes of a processing mesh according to an example implementation.

FIG. 4B is an illustration of reductions applied by the processing nodes stages according to an example implementation.

FIG. 5 is a schematic diagram illustrating a server system according to an example implementation.

FIG. 6 is a flow diagram depicting a technique to perform a collective operation in a parallel processing system according to an example implementation.

### DETAILED DESCRIPTION

A parallel computer system may include parallel processing nodes, which, in a collective, parallel processing operation, may exchange data using messaging. For example, the parallel computer system may perform a collective operation called a “reduce-scatter operation,” in which the processing nodes communicate using messaging for purposes of exchanging and applying a reduction operation on the exchanged data.

For example, the processing nodes may initially store part of a set of input data, which is subject to the reduce-scatter operation. For example, each processing node may initially store an indexed input data array, such as, for example, a data array that includes chunks indexed from one to eight. In the reduce-scatter operation, the processing nodes, through messaging, may exchange their data and apply reduction operations. For example, the reduction may be a mathematical addition, and the output data array produced by the reduce-scatter operation may be, for example, an eight element data array, where the first element is the summation of the first elements of all of the input data arrays, the second element of the output data array is the summation of the second elements of the input data arrays, and so forth. Moreover, at the conclusion of the reduce-scatter operation, the elements of the output data array are equally scattered, or distributed, across the processing nodes. For example, at the conclusion of the reduce-scatter operation, one processing node may store the first element of the output data array, another processing node may store the second element of the output data array, and so forth.

One way for a parallel processing system to perform a collective operation is for the processing to be divided into a sequence of parallel processing phases, or stages; and in stage, pairs of processing nodes exchange half of their data (one node of the pair receives one half of the data from the other node of the pair, and vice versa) and reduce the exchanged data. In this manner, in a given stage, a first processing node of a given pair of processing nodes may receive one half of the data stored on the second processing node of the pair, combine (add, for example) the received data with one half of the data stored on the first processing node and store the result on the first processing node. The second processing node of the pair, in turn, may, in the same given stage, receive one half of the data stored on the first node, combine the received data with one half of the data stored on the second node, and store the resulting reduced data on the second processing node. The processing continues in one or multiple subsequent stages in which the processing nodes exchange some of their data (e.g., half of their data), reduce the data and store the resulting reduced data, until each processing node stores an element of the resulting output data array.

In accordance with example implementations that are described herein, the pairing of the nodes for a collective operation is selected so that the initial parallel processing stage has an associated node injection bandwidth that is higher than the node injection bandwidth of any of the subsequent parallel processing stages. In this context, the “node injection bandwidth” refers to the bandwidth that is available to a given processing node for communicating data with other nodes. As an example, a given processing stage may involve nodes exchanging data, which are connected by multiple network links, so that each processing node may simultaneously exchange data with multiple other processing nodes. More specifically, as described further herein, for some stages, each processing nodes may be capable of simultaneously exchanging data with multiple processing nodes, whereas, for other stages, each processing node may exchange data with a single, other processing node.

In accordance with example implementations, a given processing stage may involve processing nodes of a supernode exchanging data, which allows each node of the supernode to simultaneously exchange data with multiple other processing nodes. In this context, a “supernode” refers to a group, or set, of processing nodes that may exchange data over higher bandwidth links than the bandwidth links used by other processing nodes. In this manner, in accordance with example implementations, the processing nodes of a given supernode may exchange data within the supernode during one parallel processing phase, or stage (the initial stage, for example), and subsequently, the given supernode may exchange data with another supernode during another parallel processing stage (a second stage, for example).

Because, as described herein, the collective operation structures the parallel processing stages so that the initial stage is associated with the highest injection bandwidth, the overall time to perform the collective operation may be significantly reduced. In this manner, the collective operation is faster because the largest volume of data is communicated over the highest bandwidth links. This reduced processing time may be particularly advantageous for deep learning, as applied to artificial intelligence and machine learning in such areas as image recognition, autonomous driving and natural language processing.

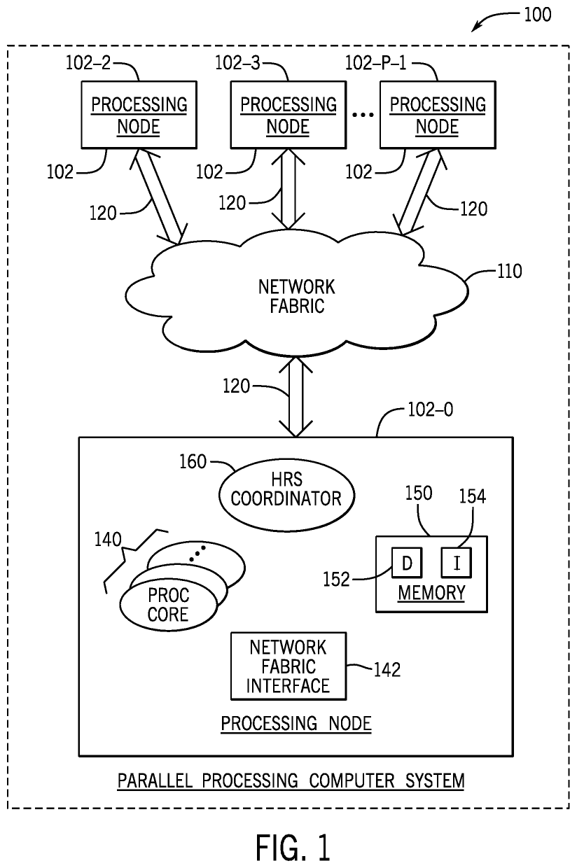

As a more specific example, FIG. 1 depicts a parallel processing computer system 100 in accordance with some implementations. In general, the computer system 100 includes multiple parallel computer processing nodes 102 (P processing nodes 102-1, 102-2, 102-3 . . . 102-P−1 being depicted in FIG. 1, as an example), which may communicate with each other over network fabric 110. In this manner, the network fabric 110 may include interconnects, buses, switches or other network fabric components, depending on the particular implementation. The processing nodes 102 may communicate with each other via the network fabric 110 to perform point-to-point parallel processing operations as well as collective processing operations. In particular, for example implementations that are described herein, the processing nodes 102 communicate with each other for purposes of parallel processing a collective operation, such as a reduce-scatter operation, in a manner that organizes the processing based on node injection bandwidth.

More specifically, for a given parallel processing phase, or stage, of the collective operation, a given processing node 102 may communicate messages with one or multiple other processing nodes 102, depending on the associated node injection bandwidth for the stage. In this manner, as an example, a given processing node 102 may have a relatively high node injection bandwidth for the initial stage, which permits the node 102 to communicate (via messaging) with three other processing nodes 102 during the stage. Other subsequent stages, however, may be associated with relatively lower node injection bandwidths.

More specifically, in accordance with example implementations, the processing nodes 102 may have differing degrees of node injection bandwidth due to various factors. For example, as described further herein, certain processing nodes 102 may be nodes of a supernode, which may communicate with three other nodes (as an example) of the super node during a particular stage. As another example, some processing nodes 102 may be coupled by a larger number of links to the network fabric 110, as opposed to other nodes 102, for a particular processing stage.

In accordance with example implementations, the processing nodes 102 may communicate with each other using a message passing interface (MPI), which is a library of function calls to allow point-to-point and collective parallel processing applications. In this manner, as depicted in FIG. 1, a given processing node 102 (here, processing node 102-0) may include one or multiple processing cores 140, network fabric interface 142 and a memory 150. In general, the memory 150 may be a non-transitory memory, which may store data 152 and machine executable instructions (or “software”) 154. The memory 150 may be formed from one or many different storage devices, such as semiconductor storage devices; magnetic storage devices; phase change memory devices; memristors; non-volatile memory devices; volatile memory devices; memory devices formed from one or more of the foregoing memory technologies; and so forth. In general, the instructions 154 when executed by one or multiple processing cores 140, may cause the processing core(s) 140 to perform operations pertaining to parallel processing a collective operation for the parallel processing computer system 100.

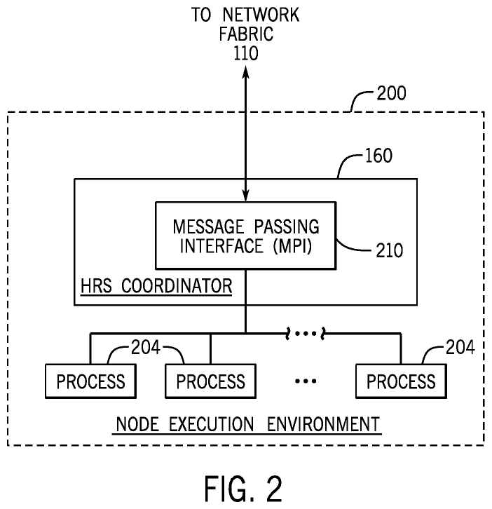

In general, the MPI provides virtual topology, synchronization and communication functionality between processes executing among the processing nodes 102. Referring to FIG. 2 in conjunction with FIG. 1, in accordance with example implementations, the processing node 102 may include a hierarchical reduce-scatter (HRS) coordinator 160, which may be formed at least in part from an MPI 210 of the node 102. As described herein, the HRS coordinator 160 coordinates the passing of messages and data among the processes 204 of the node 102 and the processes being executed on the other nodes 102 for purposes of conducting a collective operation, such as a reduce-scatter operation. In accordance with example implementations, the HRS coordinators 160 of the processing nodes 102 form a distributed HRS coordination engine to arrange the parallel processing stages for a given collective operation in an order that allows the stage having the highest associated injection bandwidth to be the initial stage in the collective operation.

In accordance with example implementations, the HRS coordinator 160 may be formed all or in part by one or multiple processing cores 140 (FIG. 1) of the processing node 102 executing machine executable instructions (instructions stored in the memory 150 (FIG. 1). In accordance with further example implementations, the HRS coordinator 160 may be formed all or in part from a circuit that does not execute machine executable instructions, such as an application specific integrated circuit (ASIC) or a field programmable gate array (FPGA).

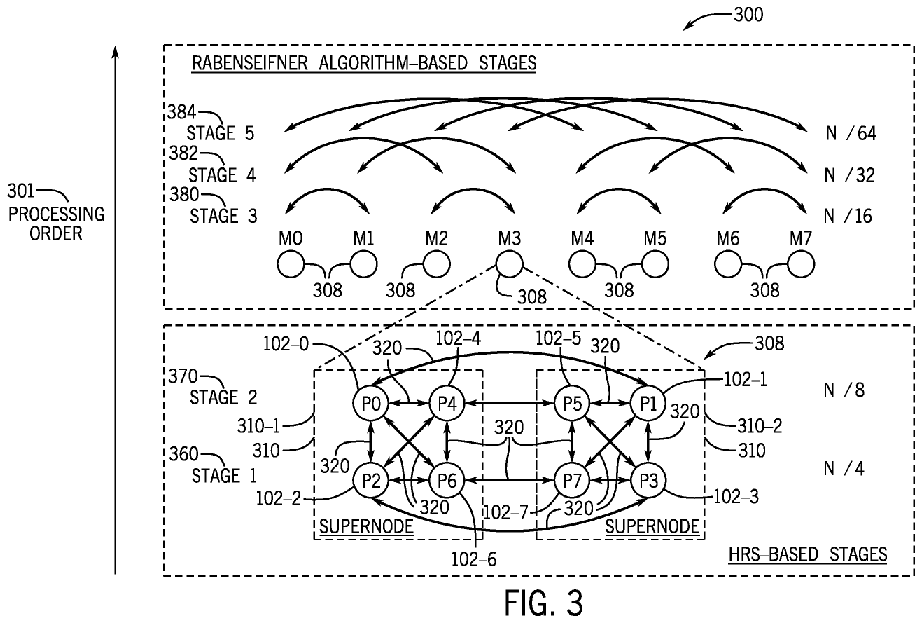

FIG. 3 is an illustration 300 of example stages of a collective parallel processing operation, such as a reduce-scatter operation, in accordance with example implementations. In general, the collective processing operation 300 follows a processing order 301 and beings with one or multiple initial HRS-based stages (two example HRS stages 360 and 370 in FIG. 3), followed by one or multiple subsequent Rabenseifner algorithm-based processing stages (three Rabenseifner algorithm-based stages 380, 382 and 384 being depicted in FIG. 3). The HRS-based stages 360 and 370, in general, are associated with higher node injection bandwidths than the Rabenseifner algorithm-based stages 380, 382 and 384; and the initial HRS-based stage 360 is associated with the highest node injection bandwidth.

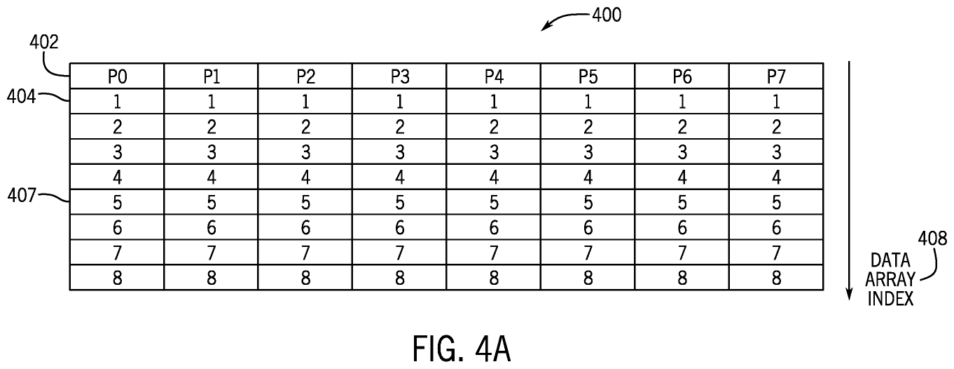

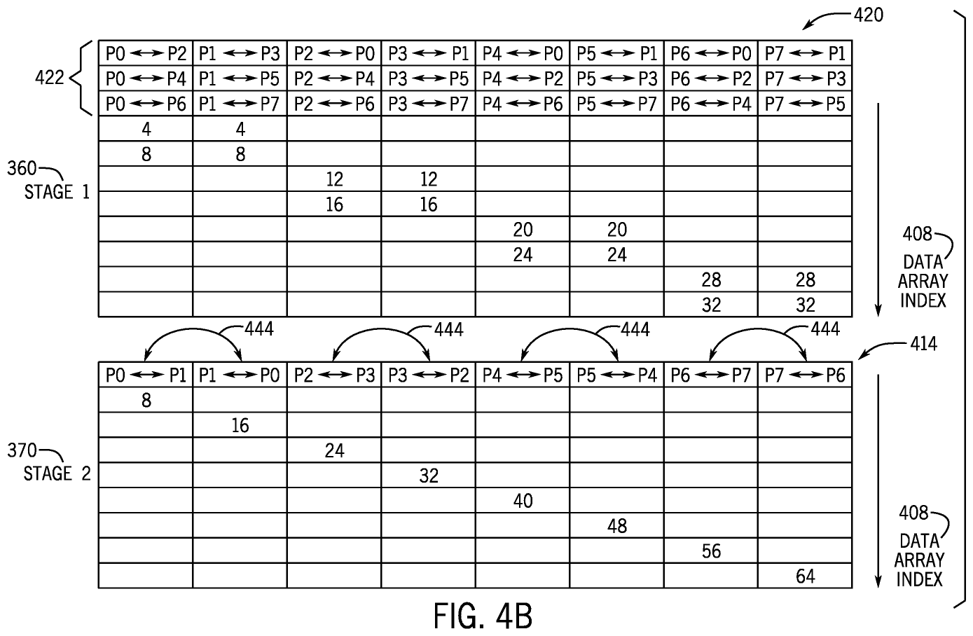

In FIG. 3, the message size is “N” bytes; and the data exchanged by each processing node 102 decreases for each stage. In this manner, as depicted in FIG. 4, in the HRS stage 360, the initial stage, each processing node 102 exchanges N/4 bytes of data; in the next stage, HRS stage 370, each processing node 102 exchanges N/8 bytes of data; in the next stage 380, each processing node 102 exchanges N/4 bytes of data; and so forth.

The HRS stage 360 has the highest injection node bandwidth due to processing nodes 102 of the same supernode 310 (two supernodes 310-1 and 310-2 being depicted in FIG. 3) exchanging data during the HRS-based stage 360. Due to the processing nodes 102 that exchange data being nodes of the same supernode 310, each processing node 102 exchanges data with three other processing nodes 102 during the HRS-based stage 360. In this manner, for the specific example of FIG. 3, the supernode 310-1 includes four processing nodes 102-0, 102-2, 102-4 and 102-6; and the supernode 310-2 includes four processing nodes 102-1, 102-3, 102-5 and 102-7. Moreover, as depicted in FIG. 3, these supernodes 310-1 and 310-2 may be grouped together to form a corresponding mesh 308; and the processing nodes 102 of one supernode 310-1, 310-2 exchange data with the processing nodes 102 of the other supernode 310-1, 310-2 during the next stage, HRS stage 370.

More specifically, the processing nodes 102 of a given supernode 310 are capable of simultaneously communicating messages with three other processing nodes 102 of the super node 310. For example, the processing node 102-0 of the supernode 310-1 may communicate (over corresponding links 320) messages with the three other processing nodes 102-4, 102-6 and 102-2 of the supernode 310-1. Therefore, during the initial HRS stage 360, for a given supernode 310, the message, having a size of N bytes is divided into four parts. Each processing node 102 exchanges its corresponding N/4 bytes of data with the three other processing nodes 102 of the supernode 310 and performs the corresponding reduction operation.

As also depicted in FIG. 3, the processing nodes 102 of each supernode 310 communicate during the next HRS stage 370. In this regard, as depicted in FIG. 3, the processing nodes 102-0 and 102-1 communicate over a corresponding link 320; the processing nodes 102-6 and 102-7 communicate over a corresponding link 320; the nodes 102-4 and 102-5 communicate over a corresponding processing link 320; and the nodes 102-2 and 102-3 communicate over a corresponding link 320. For the HRS stage 370, each processing node 102 exchanges its N/8 portion with the other processing node 102 and performs the corresponding reduction operation.

For the subsequent Rabenseifner algorithm-based stages 380, 382 and 382, processing nodes 102 of the meshes exchange data and perform corresponding reduction operations, as depicted in FIG. 3.

As a more specific example, FIG. 4A depicts an example input dataset 400 processed by the processing nodes 102 of a given mesh 308, in accordance with example implementations. The input dataset 400 includes eight data arrays, where each processing node 102 of the mesh 108 initially stores one of the eight input data arrays. For purposes of simplifying the following discussion, for this example, each input data array is <1,2,3,4,5,6,7,8>.

FIG. 4B is an illustration 420 of the data exchanges and reductions of the input dataset 400 within the mesh 308 for the input dataset 400 of FIG. 4A. In the first HRS stage 360, as illustrated at reference numeral 422, each processing node 102 of the mesh 308 exchanges data with three other processing nodes 102 of the mesh 108 and performs a corresponding reduction. Here, as an example, the reduction operation is a mathematical addition operation. Thus, as depicted in FIG. 4B, at the conclusion of the HRS stage 360, the processing nodes 102-0 and 102-1 each stores a “4” for the first array element. In other words, the processing nodes 102-0 adds its value of “1” for the first data element with the values of “1” obtained from the other three processing nodes 102-2, 102-4 and 102-6. In a similar manner, at the conclusion of the stage 360, the processing node 102-1 stores a “4” resulting from the addition of the “1” of the first element with the “1” values received from the processing nodes 102-3, 102-5 and 102-7. In a similar manner, at the end of the HRS processing stage 160, the processing node 102-2 stores a “12,” for element three, which represents the summation of one half of the third data elements of the input dataset 400.

For the second stage 370, four pairs of processing nodes 102 (one from each supernode 310) exchange half of their data elements and perform the corresponding reductions, as indicated at reference numeral 444. For example, the processing node 102-2 exchanges data with the processing node 102-3, resulting in a value of “24” for the third data element stored on the processing node 102-2 and a value of “32” for the fourth data element stored on the processing node 102-3.

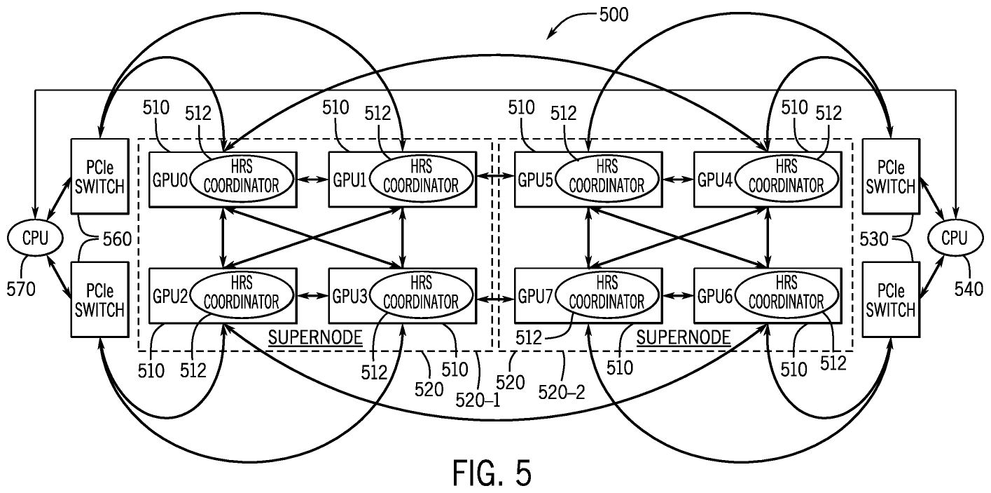

Referring to FIG. 5, in accordance with example implementations, the mesh may be part of a server 500 (a blade server card, for example). In this regard, the server 500 may include graphical processing units (GPUs) 510, which are arranged to form two supernodes 520-1 and 520-2. Moreover each GPU may include an HRS coordinator 512. As depicted in FIG. 5, the server 500 may include PCIe switches 560 that allow central processing units (CPUs) 570 to communicate with each supernode 520.

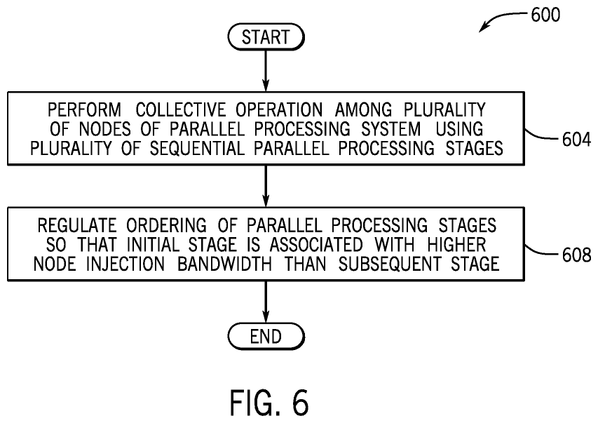

Referring to FIG. 6, thus, in accordance with example implementations, a technique 600 includes performing (block 604) a collective operation among a plurality of nodes of a parallel processing system using a plurality of sequential parallel processing stages. Pursuant to block 608 of the technique 600, an ordering of the parallel processing stages is regulated so that an initial stage is associated with a higher node injection bandwidth than a subsequent stage.

Other implementations are contemplated, which are within the scope of the appended claims. For example, in accordance with further implementations, the systems and techniques that a described herein may be applied to collective parallel processing operations other than reduce-scatter operations, such as all-reduce, all-to-all and all-gather operations.

The following examples pertain to further implementations.

Example 1 includes a computer-implemented method that includes performing a collective operation among a plurality of nodes of a parallel processing system using a plurality of parallel processing stages. The method includes regulating an ordering of the parallel processing stages, where an initial stage of the plurality of parallel processing stages is associated with a higher node injection bandwidth than a subsequent stage of the plurality of parallel processing stages.

In Example 2, the subject matter of Example 1 may optionally include communicating messages among the plurality of nodes and regulating the ordering so that a message size associated with the initial stage is larger than a message size that is associated with the subsequent stage.

In Example 3, the subject matter of Examples 1 and 2 may optionally include performing a reduce-scatter operation.

In Example 4, the subject matter of Examples 1-3 may optionally include processing elements of a data vector in parallel among the plurality of nodes to reduce the elements and scattering the reduced elements across the plurality of nodes.

In Example 5, the subject matter of Examples 1-4 may further include, for the initial stage of the plurality of processing stages, communicating a plurality of messages from a first node of the plurality of nodes to other nodes of the plurality of nodes to communicate data from the other node to the first node, and processing the communicated data in the first node to apply a reduction operation to the communicated data.

In Example 6, the subject matter of Examples 1-5 may optionally include the plurality of nodes including clusters of nodes, communicating messages among the nodes of each cluster in the initial stage, and communicating messages among the clusters in the subsequent stage.

In Example 7, the subject matter of Examples 1-6 may optionally include the plurality of nodes including subsets of nodes arranged in supernodes, communicating messages among the nodes of each supernode in the initial stage, and communicating messages among the supernodes in the subsequent stage.

In Example 8, the subject matter of Examples 1-7 may optionally include the plurality of nodes including subsets of nodes arranged in supernodes, and subsets of supernodes arranged in meshes. The method may include communicating messages among the nodes of each supernode in the initial stage; communicating messages among the supernodes of each mesh in a second stage of a plurality of parallel processing stages; and communicating messages among the meshes in a third stage of the plurality of parallel processing stages.

In Example 9, the subject matter of Examples 1-8 may optionally include the subsets of nodes being arranged in supernodes, and subsets of the supernodes being arranged in meshes. The method may further include communicating messages among the nodes of each supernode in the initial stage; communicating messages among the supernodes of each mesh in a second stage of the plurality of parallel processing stages; and communicating messages among the messages in a plurality of other stages of the plurality of parallel processing stages.

In Example 10, the subject matter of Examples 1-9 may optionally include communicating messages among the meshes in a plurality of other stages of the plurality of parallel processing stages including communicating according to a Rabenseifner-based algorithm.

Example 11 includes a non-transitory computer readable storage medium to store instructions that, when executed by a parallel processing machine, causes the machine to for each stage of a plurality of parallel processing stages, communicate messages among a plurality of processing nodes of the machine to exchange and reduce data, where each processing stage is associated with an injection bandwidth, and the injection bandwidths differ. The instructions, when executed by the parallel processing machine, causes the machine to order the stages so that an initial stage of the plurality of parallel processing stages is associated with the highest injection bandwidth of the associated injection bandwidths.

In Example 12, the subject matter of Example 11 may optionally include the computer readable storage medium storing instructions that, when executed by the parallel processing machine, cause the machine to provide a message interface library providing a function that allows ordering of the stages, and the initial stage is associated with the highest injection bandwidth.

In Example 13, the subject matter of Examples 11 and 12 may optionally include the computer readable storage medium storing instructions that, when executed by the parallel processing machine, cause the machine to order the stages according to the associated injection bandwidths so that a stage associated with a relatively higher injection bandwidth is performed before a stage associated with a relatively lower injection bandwidth.

In Example 14, the subject matter of Examples 11-13 may optionally include the plurality of processing nodes including subsets of nodes arranged in supernodes; and subsets of the supernodes being arranged in meshes. The computer readable storage medium may store instructions that, when executed by the parallel processing machine, cause the nodes of each supernode to communicate with each other to reduce data in the initial stage, cause the supernodes of each mesh to communicate with each other to reduce data in a second stage of the plurality of parallel processing stages, and cause the meshes to communicate with each other to reduce data in at least one other third stage of the plurality of parallel processing stages.

Example 15 includes system that includes a plurality of processing meshes to perform a reduce-scatter parallel processing operation for a first dataset. Each mesh includes a plurality of supernodes; and each supernode includes a plurality of computer processing nodes. The system includes a coordinator to separate the reduce-scatter parallel processing operation into a plurality of parallel processing phases including a first phase, a second phase and at least one additional phase. In the initial phase, the computer processing nodes of each supernode communicate messages with each other to reduce the first dataset to provide a second dataset; in the second phase, the supernodes of each mesh communicate messages with each other to reduce the second dataset to produce a third dataset; and in the at least one additional phase, the meshes communicate messages with each other to further reduce the third dataset.

In Example 16, the subject matter of Example 15 may optionally include the coordinator including a Message Passing Interface (MPI).

In Example 17, the subject matter of Examples 15 and 16 may optionally include the computer processing node including a plurality of processing cores.

In Example 18, the subject matter of Examples 15-17 may optionally include, in the initial phase, a given computer processing node of a given supernode communicating multiple messages with another computer processing node of the given supernode.

In Example 19, the subject matter of Examples 15 to 18 may optionally include in a third phase of the at least one additional phase, each mesh communicating a single message with another mesh.

In Example 20, the subject matter of Examples 15 to 19 may optionally include the computer processing node including a server blade.

While the present disclosure has been described with respect to a limited number of implementations, those skilled in the art, having the benefit of this disclosure, will appreciate numerous modifications and variations therefrom. It is intended that the appended claims cover all such modifications and variations

What is claimed is:

1. A computer-implemented method comprising:
performing a collective operation among a plurality of nodes of a parallel processing system using a plurality of parallel processing stages; and
regulating an ordering of the parallel processing stages, wherein an initial stage of the plurality of parallel processing stages is associated with a higher node injection bandwidth than a subsequent stage of the plurality of parallel processing stages.

2. The method of claim 1, wherein:
performing the collective operation comprises communicating messages among the plurality of nodes; and
regulating the ordering comprises regulating the ordering so that a message size associated with the initial stage is larger than a message size associated with the another stage.

3. The method of claim 1, wherein performing the collective operation comprises performing a reduce-scatter operation.

4. The method of claim 1, wherein performing the collective operation comprises processing elements of a data vector in parallel among the plurality of nodes to reduce the elements and scattering the reduced elements across the plurality of nodes.

5. The method of claim 1, further comprising:
for the initial stage of the plurality of parallel processing stages, communicating a plurality of messages from a first node of the plurality of nodes to other nodes of the plurality of nodes to communicate data from the other node to the first node, and processing the communicated data in the first node to apply a reduction operation to the communicated data.

6. The method of claim 1, wherein the plurality of nodes comprises clusters of nodes, the method further comprising:
communicating messages among the nodes of each cluster in the initial stage; and
communicating messages among the clusters in the subsequent stage.

7. The method of claim 1, wherein the plurality of nodes comprises subsets of nodes arranged in supernodes, the method further comprising:
communicating messages among the nodes of each supernode in the initial stage; and
communicating messages among the supernodes in the subsequent stage.

8. The method of claim 1, wherein the plurality of nodes comprises subsets of nodes arranged in supernodes, and subsets of supernodes arranged in meshes, the method further comprising:
communicating messages among the nodes of each supernode in the initial stage;
communicating messages among the supernodes of each mesh in a second stage of the plurality of parallel processing stages; and
communicating messages among the meshes in a third stage of the plurality of parallel processing stages.

9. The method of claim 1, wherein the plurality of nodes comprises subsets of nodes arranged in supernodes, and subsets of supernodes arranged in meshes, the method further comprising:
communicating messages among the nodes of each supernode in the initial stage;
communicating messages among the supernodes of each mesh in a second stage of the plurality of parallel processing stages; and
communicating messages among the meshes in a plurality of other stages of the plurality of parallel processing stages.

10. The method of claim 9, wherein communicating messages among the meshes in a plurality of other stages of the plurality of parallel processing stages comprises communicating according to a Rabenseifner-based algorithm.

11. A non-transitory computer readable storage medium to store instructions that, when executed by a parallel processing machine, causes the machine to:
for each stage of a plurality of parallel processing stages, communicate messages among a plurality of processing nodes of the machine to exchange and reduce data, wherein each processing stage is associated with an injection bandwidth, and the injection bandwidths differ; and
order the stages so that an initial stage of the plurality of parallel processing stages is associated with the highest injection bandwidth of the associated injection bandwidths.

12. The computer readable storage medium of claim 11, wherein the computer readable storage medium stores instructions that, when executed by the parallel processing machine, cause the machine to provide a message interface library providing a function that allows ordering of the stages, and wherein the initial stage is associated with the highest injection bandwidth.

13. The computer readable storage medium of claim 11, wherein the computer readable storage medium stores instructions that, when executed by the parallel processing machine, cause the machine to order the stages according to the associated injection bandwidths so that a stage associated with a relatively higher injection bandwidth is performed before a stage associated with a relatively lower injection bandwidth.

14. The computer readable storage medium of claim 11, wherein:
the plurality of processing nodes comprises subsets of nodes arranged in supernodes;
subsets of the supernodes are arranged in meshes; and
the computer readable storage medium stores instructions that, when executed by the parallel processing machine, cause the nodes of each supernode to communicate with each other to reduce data in the initial stage, cause the supernodes of each mesh to communicate with each other to reduce data in a second stage of the plurality of parallel processing stages, and cause the meshes to communicate with each other to reduce data in at least one other third stage of the plurality of parallel processing stages.

15. A system comprising:
a plurality of processing meshes to perform a reduce-scatter parallel processing operation for a first dataset, wherein:
each mesh comprises a plurality of supernodes; and
each supernode comprises a plurality of computer processing nodes; and
a coordinator to separate the reduce-scatter parallel processing operation into a plurality of parallel processing phases comprising a first phase, a second phase and at least one additional phase,
wherein:
in the initial phase, the computer processing nodes of each supernode communicate messages with each other to reduce the first dataset to provide a second dataset;
in the second phase, the supernodes of each mesh communicate messages with each other to reduce the second dataset to produce a third dataset; and
in the at least one additional phase, the meshes communicate messages with each other to further reduce the third dataset.

16. The system of claim 15, wherein the coordinator comprises a Message Passing Interface (MPI).

17. The system of claim 15, wherein the computer processing node comprises a plurality of processing cores.

18. The system of claim 15, wherein in the initial phase, a given computer processing node of a given supernode communicates multiple messages with another computer processing node of the given supernode.

19. The system of claim 18, wherein, in the at least one additional phase comprises a third phase, and in the third phase, each mesh communicates a single message with another mesh.

20. The system of claim 15, wherein the computer processing node comprises a server blade.
